(19) United States
(12) Patent Application Publication
(10) Pub. No.: US 2002/0078463 A1
(43) Pub. Date: Jun. 20, 2002

(54) Method and processor engine architecture for the delivery of dynamically compressed audio video content over a broadband network

(76) Inventor: Mark J. Foster, Palo Alto, CA (US)

Correspondence Address: GLENN PATENT GROUP, 3475 EDISON WAY, SUITE L, MENLO PARK, CA, 94025, US

(21) Appl. No.: 09/740,631

(22) Filed: Dec. 18, 2000

Related U.S. Application Data
(60) Provisional application No. 60/210,440, filed on Jun. 8, 2000.

(51) Int. Cl. H04N 7/173

(52) U.S. Cl. 725/95; 725/86

(57) ABSTRACT

A method and processor architecture that implements the delivery of compressed digital video and audio content over a broadband network is disclosed.

### CROSS REFERENCE TO RELATED APPLICATIONS

This application is related to U.S. Serial No. 60/210,440 filed Jun. 8, 2000 (AGLE0001 PR), entitled “Method and Apparatus for Centralized Voice-Driven Natural Language Processing in Multi-Media and High Band” by inventors Ted Calderone, Paul Cook, and Mark Foster and to U.S. Ser. No. 09/679,115 filed Oct. 4, 2000 (AGLE0003), entitled “System and Method of a Multi-Dimensional Plex Communication Network” by Theodore Calderone and Mark J. Foster.

### FIELD OF THE INVENTION

The present invention relates to the field of delivering compressed audio or video (AV) content over a broadband network. The present invention further relates to the field of delivering over a broadband network, user requested AV content that is dynamically compressed depending upon the available bandwidth of the broadband network.

### BACKGROUND

Access to the Internet has experienced widespread growth. Owing to the growth in access has been the decreased cost of the software and hardware necessary for gaining access. However, notwithstanding the decreased cost of the hardware necessary for accessing the Internet, a significant segment of the population still cannot afford the costs associated with the traditional hardware necessary to access the Internet. Thus, while the Internet has the potential to positively impact people's lives, economic barriers remain a substantial impediment to many. It follows that a need exists for a less expensive Internet access means to reach that segment of the population that cannot ordinarily afford an Internet access system.

Ordinarily, one must sacrifice performance to provide a more affordable Internet access system. Thus, Internet access system designers have sacrificed performance as they looked for ways to save costs. At least one prior Internet access system takes advantage of the circumstance that a great number of homes already have televisions and uses the television CRT and sound system through which the output of a Internet application session is conveyed to the user. This prior art solution however features complex consumer electronics that rival the cost and complexity of most desktop Internet access systems. Moreover, this prior art solution further requires a separate physical transport media for the bi-directional communications between each STB 500 and the Internet Service Provider (ISP).

Most homes are also connectable to a Residential Broadband (RBB) Access Network. A generic cable-television (CATV) Hybrid Fiber Coaxial (HFC) network is an example of such an RBB network Referring to FIG. 1, a generic HFC network is characteristically hierarchical and comprises a Metropolitan Headend 92 coupled to a plurality of local Headends 94, each local Headend 94 being further coupled to a plurality of Nodes 96. In a point-to-multipoint (PTMP) Access Network, each Node 96 is further coupled to a plurality of Set-Top-Boxes (“STB”) 500 via a shared coaxial line—typically through a local interface 98 that provides bi-directional amplification of the HFC network communications.

The HFC network is currently used as a transport layer to deliver digitally compressed CATV programming to homes. Particularly, current digital CATV systems use MPEG2 transport streams (TS) and require that the home display device include a MPEG2 decoder. MPEG2 TS comprise audio, video, text or data streams that further include PIDs. A PID identifies the desired TS for the MPEG2 decoder and is mapped to a particular program in a Program Map Table (PMT). Thus, a PID table and PMT within the decoder define the possible program choices for a digital CATV decoder and tuning a program for a digital CATV STB 500 comprises joining a TS of MPEG2 encoded frames. The PID table and PMT are remotely updated by the CATV service provider when the viewers choices for programming change.

MPEG2 compression is well known in the art. MPEG2 compression features both spatial and temporal compression. MPEG2 spatial compression comprises an application of the Discrete Cosine Transform (DCT) on groups of bits (e.g. 8×8 pixel blocks) that comprise a complete and single frame of visual content to distill an array of DCT coefficients that is representative of the frame of visual content. The resulting array of DCT coefficients are subsequently submitted to Huffman run-length compression. The array of compressed DCT coefficients represents one frame of displayable video and is referred to as an Intra frame (I-frame).

Temporal compression in MPEG2 comprises using knowledge of the contents of the prior video frame image and applying motion prediction to further bit reduction. MPEG2 temporal compression uses Predicted frames (P-frames) which are predicted from I-frames or other P-frames, and Bi-directional frames (B-frames) that are interpolated between I-frames and P-frames. An increased use of B-frames and P-frames account for the greatest bit reduction in MPEG2 TS and can provide acceptable picture quality so long as there is not much motion in the video or no substantial change in the overall video image from frame to frame. The occurrence of a substantial change in the video display requires calculation and transmittal of a new I-frame. An MPEG2 Group of Pictures (GoP) refers to the set of frames between subsequent I-frames.

The HFC network may also support upstream data communication from each STB 500 in the 5-40 MHz frequencies. If so, upstream data communication is typically supported between each STB 500 and upstream communications receiving equipment 97 (hereinafter “RCVR 97”) situated either at the Node 96 or the Headend 94. Upstream communication from each STB 500 enables requests for special programming to be communicated to the cable television service provider (e.g. request a Program Identifier (PID) associated with a particular pay per view program). Upstream data communication also conveniently permits collective management of the plurality of STBs 500 by an administrative function that is conveniently located elsewhere on the HFC.

Thus, one potential means of providing Internet access uses the RBB network such as the CATV HFC network as the transport layer through which bi-directional data communications are conveyed to and from an ISP. However, the upstream bandwidth on the HFC network is limited, and will without doubt come under increased demands as this prior art solution and other applications seek to take advantage of this HFC network capability. Therefore, the efficient use of this limited upstream bandwidth presents a hurdle to creators of bi-directional communication based applications implemented on the HFC network.

One potential approach that accommodates the limited upstream bandwidth uses the home television as a display device, and a STB 500 incorporating the functions of a “thin” remote client. The remote client may be incorporated into the STB 500 for convenience. See FIGS. 2a and 2b. The remote client requires only that amount of hardware and software necessary to send Internet application commands and a unique PID upstream to the RCVR 97. At the Headend 94 or Node 96, commands and PIDs are conveyed from the RCVR 97 to an Ethernet Switch that is further coupled to a plurality of distinct AV content processing boards.

FIG. 3 depicts a representative diagram of this prior-art solution that can accommodate delivering MPEG video content to multiple remote clients via the HFC network. In this solution, each AV content processing board establishes an Internet application session for each remote client that requests Internet AV content. The Internet AV content processing board recovers the requested Internet content and outputs the AV content to the STB 500 in a MPEG transport stream appended to a PID expected by the STB 500.

This solution presents a more affordable solution for the end consumer as it shifts a substantial portion of the hardware and software costs that would typically impact the home up the RBB network to the CATV services provider, where the cost can be amortized over many users. This approach also permits the implementation of a relatively high performance Internet AV content delivery system. In contrast, the prior art solution however suffers substantial cost and complexity for the RBB administrator and would likely therefore deter a RBB administrator from implementing the system depicted in FIG. 3. It follows that reducing costs for the RBB administrator has the potential to increase industry acceptance of Internet AV content delivery over the HFC network. Accordingly, there is a need for less expensive system design that is capable of processing and retrieving the Internet content requested by remote clients, and delivering that Internet content in a format recognizable by remote clients.

Further, requests for user requested video services or Internet AV display content tends to be random and subject to periods of increased demand. Thus, it would be advantageous to further provide a means of dynamically adjusting the compression efficiency of the Internet Browser display content delivered to remote clients.

Thus, FIG. 3 also includes a depiction of Statistical Multiplexer 2. The Statistical Multiplexer 2 can advantageously provide dynamic adjustment of the bandwidth allocated to each bit stream of video depending on the number of bit streams, the complexity of the bit streams, and the overall available bandwidth. The Statistical Multiplexer 2 however adds further cost to the system design and adds a potential point of failure. If the Statistical Multiplexer 2 fails, the whole delivery system fails. Thus, it would be advantageous to eliminate the Statistical Multiplexer 2 in the AV content delivery system to save both cost and system complexity.

### SUMMARY OF THE INVENTION

The present invention generally comprises a method of dynamically adjusting the compression ratio of compressed audio or video (AV) content delivered over a broadband network to a decoder in a STB 500.

The method comprises the use of an AV Engine comprising at least two processing nodes including an Processing Node (PN) coupled to an Input/Output Node (“ION”). The ION is further coupled to a switched network, which enables the AV Engine to retrieve AV content to the PN. The ION is further coupled to the RBB RCVR 97, which enables bi-directional data communication between the AV Engine and the STB 500. Data communication between the AV Engine and the STB 500 enables requests for AV content to be sent to the AV Engine by the STB 500; and channels and PIDs that will be incorporated with the retrieved and compressed AV content sent to the STB 500 by the AV Engine.

The PN creates a spatially compressed frame of the AV content and signals to the ION the availability of the spatially compressed frame of AV content a unique PID. The ION accesses the local memory to retrieve the spatially compressed frame of Internet AV content and creates temporally compressed frames based on the spatially compressed frame. The ION then transmits a stream of frames comprising a spatially and temporally compressed representation of the Internet AV content with the unique PID to the requesting STB 500.

The overall bandwidth available on the RBB to deliver compressed AV content to remote clients will vary depending on the quantity of CATV programming, the quantity of AV content requested, and the composition of the AV content that is requested. Accordingly, the AV Engine is adapted to receive feedback regarding the availability of bandwidth on the RBB. Feedback regarding the availability of bandwidth is potentially conveyed from the Metropolitan Headend 92, the local Headend 94, the Node 96 or the AV Engine itself (collectively hereinafter “BAF”).

The AV Engine dynamically adjusts the compression efficiency of the stream of frames comprising the spatial and temporally compressed AV content depending upon the available bandwidth of the RBB. In certain embodiments of the invention, the compression ratio of the I-frame is increased due to reductions of RBB bandwidth. In other embodiments the frame rate of the AV content is decreased in response to a reduction of the available RBB bandwidth. In still other embodiments, the picture resolution is decreased in response to reductions of available RBB bandwidth.

Certain embodiments of the invention access Internet servers through the switched network to obtain requested AV content.

Certain embodiments of the invention access a video-on-demand server through the switched network to obtain requested AV content.

Certain embodiments of the invention enable the recognition and delivery of previously compressed audio and motion video to a requesting STB 500 without duplicative attempts at compression by the AV Engine.

Certain other embodiment of the invention provide for the delivery of video on demand services.

Certain other embodiments of the invention implement the use an array of processing nodes wherein at least a portion of the processing nodes perform the function of the PN and at least another portion of the processing nodes perform the function of the ION.

Finally, the RBB network depicted in FIG. 1 is for illustrative purposes only and is not intended to imply that the method or apparatus of the present invention to be described in the disclosure below is limited to any particular RBB network architecture. In light of the disclosure that follows, it is within the knowledge of an ordinarily skilled practitioner to modify the method and device of the present invention for alternate RBB network architectures.

### BRIEF DESCRIPTION OF THE DRAWINGS

FIG. 1 depicts a generic residential broadband HFC network.

FIG. 2a depicts a first embodiment of a thin remote client set top box.

FIG. 2b depicts a second embodiment of a thin remote client set top box.

FIG. 3 depicts a prior art system for delivering compressed video content to set top boxes.

FIG. 4a depicts a first embodiment of the present invention.

FIG. 4b depicts a second embodiment of the present invention.

FIG. 4c depicts a third embodiment of the present invention.

FIG. 4d depicts a fourth embodiment of the present invention.

FIG. 5a depicts an array of processing nodes that are orthogonally coupled.

FIG. 5b depicts an array of processing nodes that are orthogonally coupled.

FIG. 6a depicts an embodiment of a processing architecture implementing the method of the present invention.

FIG. 6b depicts an embodiment of a first array of processing architecture implementing the method of the present invention.

FIG. 6c depicts an embodiment of a second array of processing architecture implementing the method of the present invention.

FIG. 6d depicts a cross-coupling between the first and second array of processing architecture implementing the method of the present invention.

FIG. 7a depicts a flow diagram representing the operation of an embodiment of a Processing Node of the present invention.

FIG. 7b depicts a flow diagram representing an embodiment of the step of increasing the compression ratio of the spatially compressed AV content.

FIG. 8a depicts a flow diagram representing an embodiment of the step of increasing the compression ratio of the spatially compressed AV content.

FIG. 8 depicts a flow diagram representing an embodiment of the step of increasing the temporal compression of the AV content.

FIG. 9 depicts a flow diagram representing the operation of an embodiment of a Control Processing Node of the present invention.

### DESCRIPTION OF THE PREFERRED EMBODIMENTS

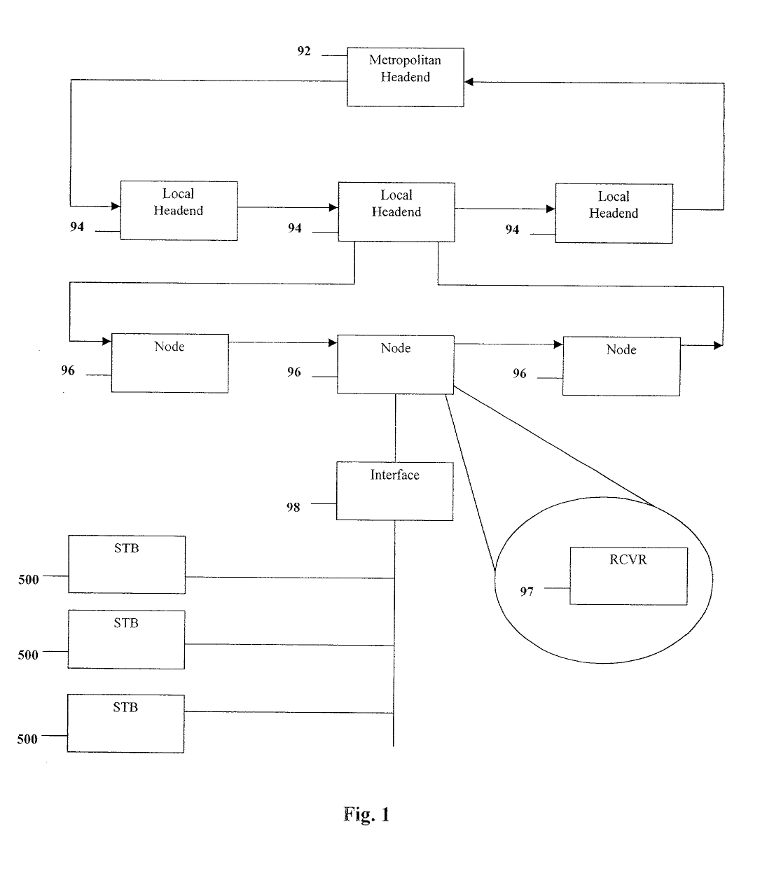

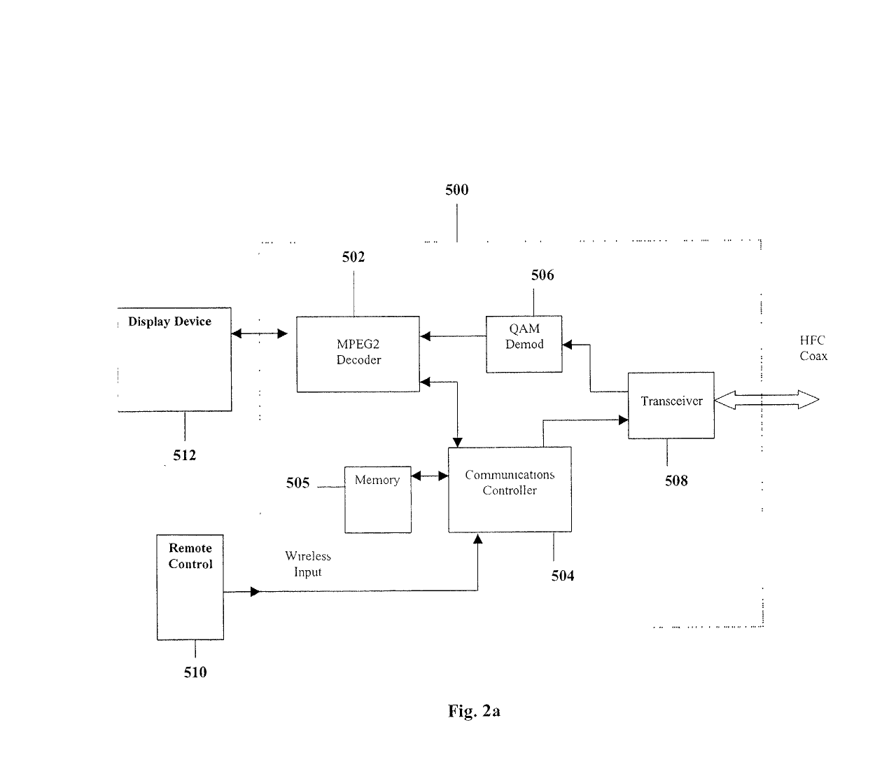

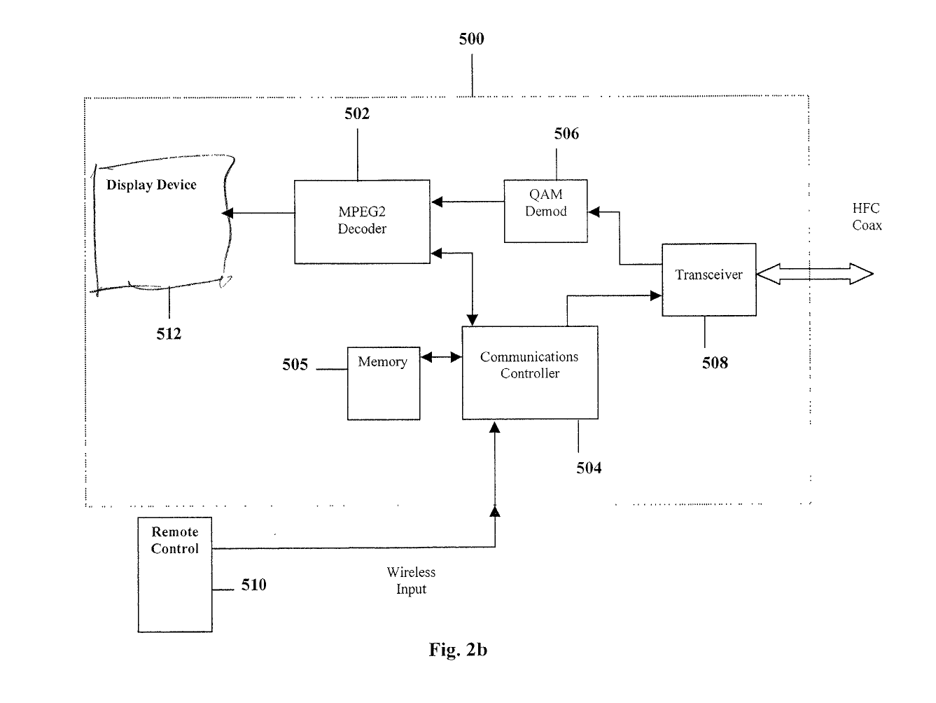

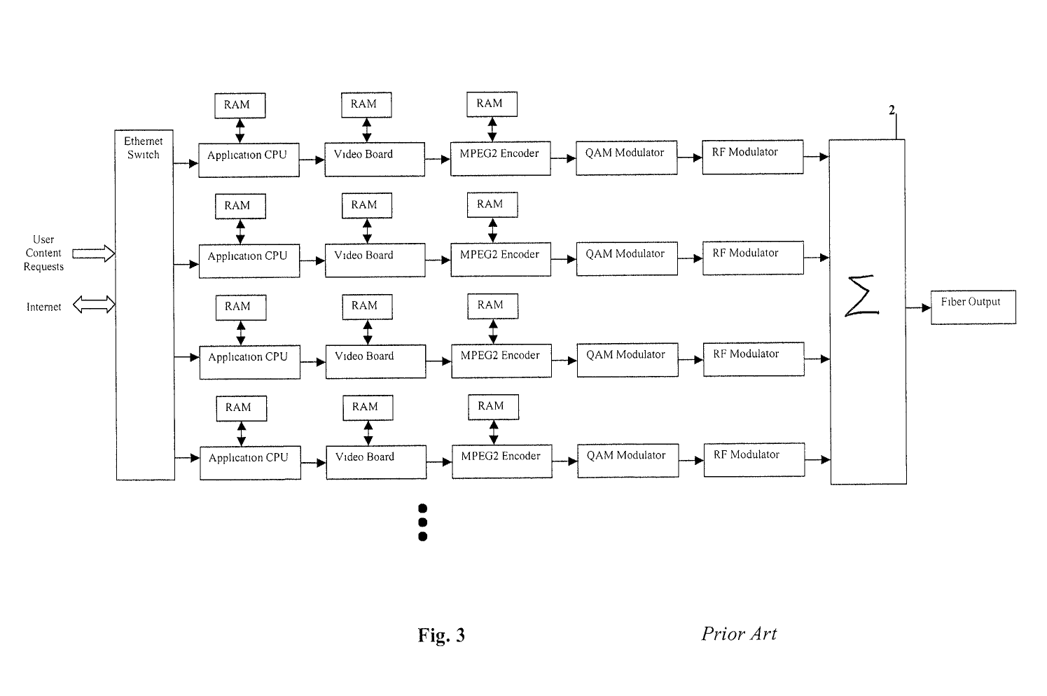

The preferred embodiment of the present system is useful for the delivery of compressed AV content to a remote client via the existing CATV RBB network. Referring to FIG. 1, operation of the disclosed embodiments is initiated when a remote client sends a request for Internet AV content to an AV Engine implementing the present invention. The request from the remote client for AV content may be transmitted to the present invention through the upstream data path to the RCVR 97 of the RBB network, which is coupled to the present invention; through a separate telephone line coupled to the present invention by a telephony server; or through another custom communication path.

For the purposes of this description, a remote client includes upstream transmission capability and is coupled to Terminal Equipment (TE) at the subscriber location. TE includes computer hardware and software capable of decoding and displaying spatially and temporally compressed AV content. For the purposes of this description, AV content includes still frames of video, frames of motion video, and frames of audio.

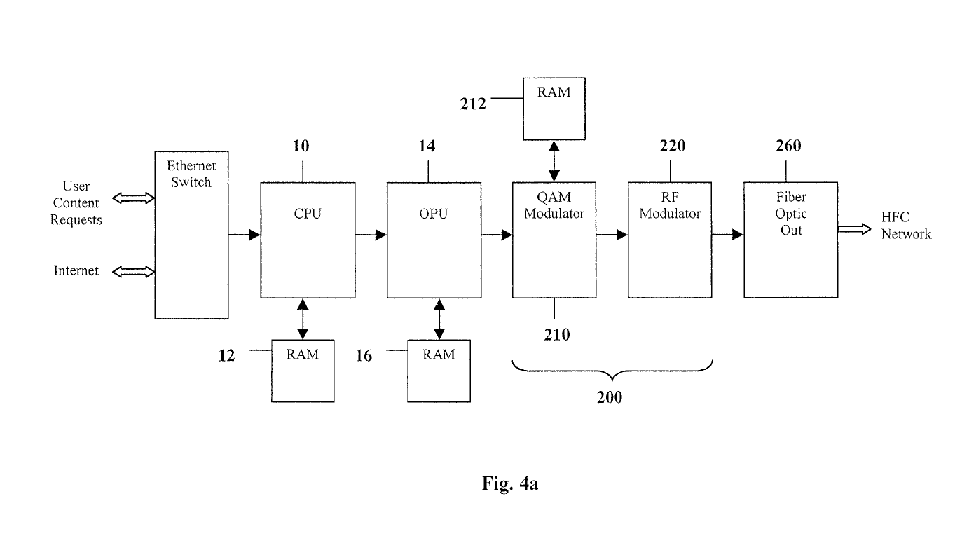

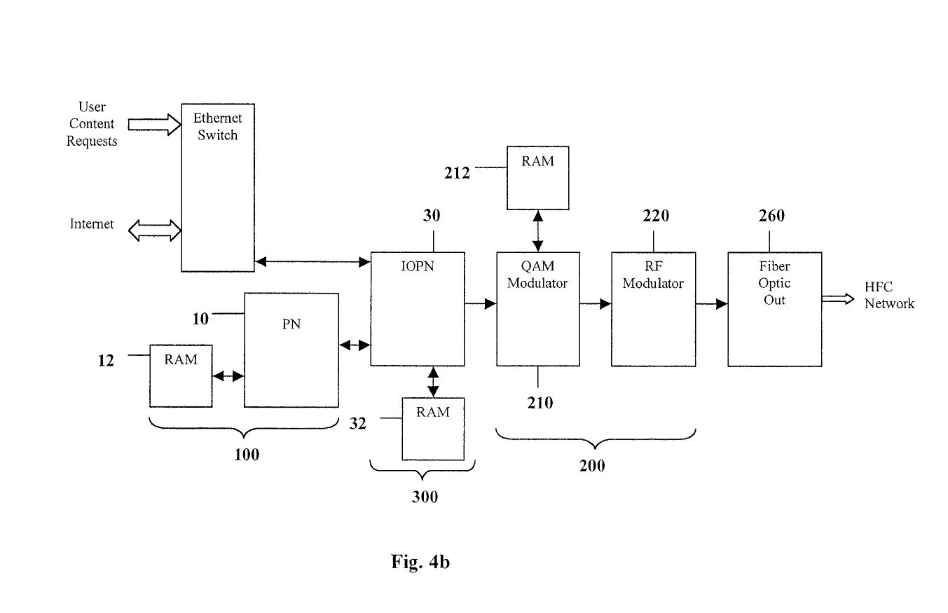

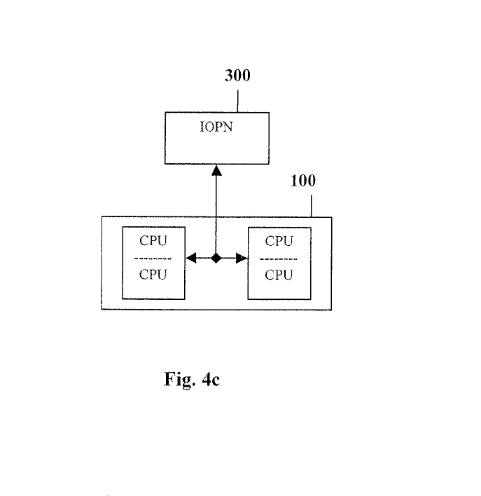

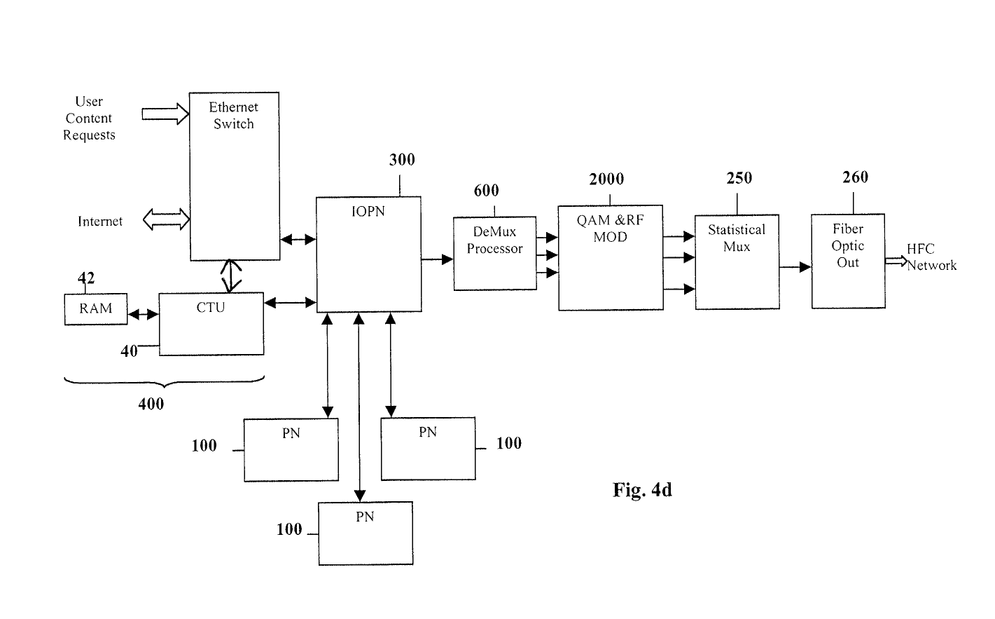

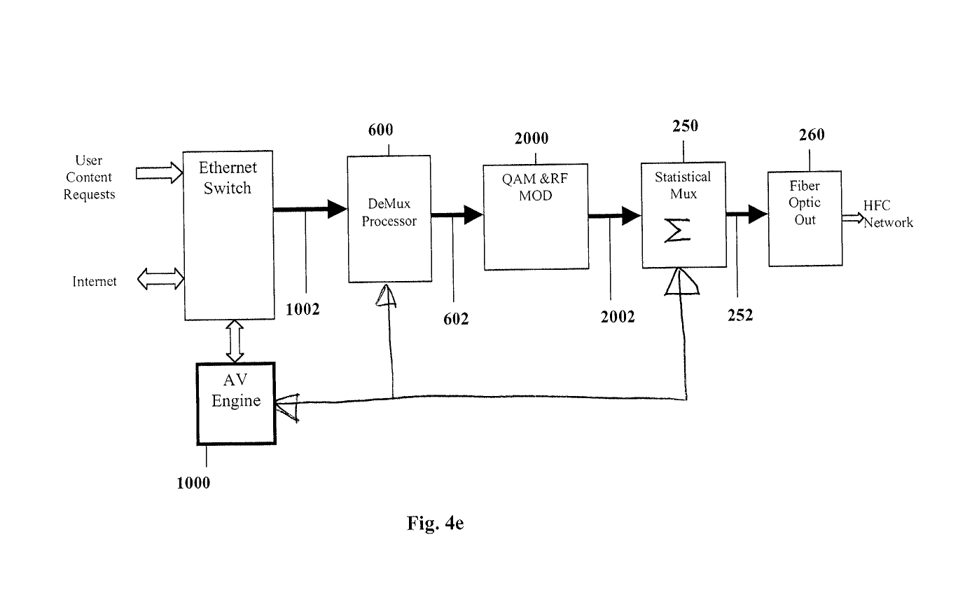

FIG. 4a depicts a first embodiment of the AV Engine. The AV content request from the remote client is communicated to the AV Engine from the RCVR 97. The RCRV 97 may be coupled to the AV Engine using an Ethernet switch. In the first embodiment, the AV engine comprises a Central Processing Unit (CPU) 10 coupled to local memory 12, and also coupled to an Output Processing Unit (OPU) 14 that is further coupled to local memory 16. The CPU 10 and OPU 14 preferably each comprise an instruction set processor that changes state based upon a program instruction. The CPU 10 may be coupled to the OPN 14 using a variety of high-speed bi-directional communication technologies. Preferred communication technologies are based upon point-to-point traversal of the physical transport layers of the CPU 10 and the OPU 14 and may include a databus, fiber optics, and microwave wave guides. Such communication technologies may also include a messaging protocol supporting TCP-IP for example. Further embodiments support Wavelength Division Multiplex (WDM) communications through the physical transport layer coupling the CPU 10 and OPU 14.

Upon receipt of the AV content request, an application session is initiated on the CPU 10. Moreover, the CPU 10 communicates back to the remote client to update the PID table and PMT of the remote client to contain a channel and PID that will carry the remote client's requested AV content. The CPU 10 is further coupled to a switched network such as the Internet through which AV content may be accessed and retrieved. Thus, the application session operated on the CPU 10 may comprise an Internet Browser application session that accesses Internet servers or databases available on the World Wide Web. The CPU 10 is coupled to memory 12 and controlled by application software to access the switched network and retrieve the AV content requested by the remote client and render the retrieved AV content to memory 12. The first embodiment further includes a software module that controls the CPU 10 to spatially compress the AV content. The presently preferred spatial compression performed on the AV content creates a MPEG2 I-frame without the traditional data overhead necessary to identify the program stream to a STB 500. Thereafter, CPU 10 passes the I-frame to the OPU 14 along with the unique PID with which to associate the MJPEG frame. The OPU 14 receives the MJPEG frame and stores it to memory 16. The OPU 14 is controlled by software to add three classes of information that transforms the MJPEG frame into an MPEG2 TS GoP. First, formatting data is included by the OPU 14 that transforms the MJPEG frame into an MPEG2 I-frame. The formatting necessary to perform the MJPEG to MPEG2 I-frame is considered to be obvious to one of ordinary skill in the art. Next, the OPU 14 calculates MPEG2 P-frames and B-frames to render a MPEG2 TS. Finally, the OPU 14 appends the unique PID expected by the remote client and commences transmission of the MPEG2 TS representing the requested AV content. The MPEG2 transport stream representing the AV content is subsequently output to a Quadrature Amplitude Modulator (QAM) 210 and RF upconverter 220 (collectively hereafter “Post Processing 200”) and transmitted 260 through the RBB network to the remote client at a sufficient rate to ensure adequate picture quality on the TE.

The same MPEG-2 transport stream that includes the first calculated GoP will be continuously transmitted by the AV Engine to the remote client until either new AV content is requested and the OPU 14 receives a new MJPEG frame, or until the application session is terminated either by a command from the remote client or by prolonged inactivity. If the CPU 10 receives a subsequent request for AV content from the remote client, the process begins again generating a new MPEG2 transport stream representing the newly acquired AV content.

In a second embodiment depicted in FIG. 4b, the AV engine comprises a Input/Output Processing Node (IOPN) 30 coupled to local memory 32 (collectively “IOPN 300”) and a Processing Node (PN) 100 including local memory 12 (collectively “PN 100”). The PN 100 comprises at least one instruction set central processing unit (CPU) that changes state based upon a program instruction. Certain embodiments of the invention include a PN 100 comprising a plurality of instruction set CPUs. FIG. 4c depicts the interconnection between such type PN 100 and a IOPN 300. In such embodiments, each of the plurality of instruction set CPUs may actually comprise a pair of dual-CPUs that are bi-directionally coupled to the other dual-CPU and the IOPN 300.

Each dual-CPU within the PN 100 may be coupled to the other dual-CPU and the IOPN 300 using a variety of high-speed bi-directional communication technologies. Preferred communication technologies are based upon point-to-point traversal of the physical transport layers of the dual-CPU and the IOPN 300 and may include a databus, fiber optics, and microwave wave guides. Such communication technologies may also include a messaging protocol supporting TCP-IP for example. Further embodiments support Wavelength Division Multiplex (WDM) communications through the physical transport layer coupling the dual-CPU and IOPN 300.

In this second embodiment, the IOPN 300 communicates all the throughput traffic to and from the AV engine and is therefore coupled to the switched network, the RCVR 97, the PN 100, and the post processing 200 hardware. The IOPN 300 interfaces with the switched network to process the AV content requests of the PN 100 and may be coupled to the switched network with an Ethernet switch or equivalent. The IOPN 300 preferably couples to RCVR 97 and the post processing 200 hardware using high speed fiber-optic interconnects.

FIG. 4d depicts a third embodiment that further includes a Control Processor Unit 40 with memory 42 (collectively “CPN 400”). At least one additional PN 100 may optionally be included in this embodiment. The IOPN 300 includes the quantity of communication ports to directly cross-couple each of the either CPN 400 or plurality of PN 100. As with the previous embodiment, communication between the CPN 400 and the IOPN 300, or the PN 100 and the IOPN 300 requires traversal of the physical transport layer of the IOPN 300, the PN 100, or the CPN 400. Accordingly, the preferred physical transport layer includes high-speed technologies including fiber-optics, databus, and microwave wave guides. The CPN 400 may be an instruction set computer that changes state upon the execution of a program instruction. Moreover, the CPN 400 may also comprise a dual-CPU such as that depicted in FIG. 4c and coupled to the IOPN 300 in the same manner as the PN 100.

As with the previous embodiment, the IOPN 300 is coupled to the switched network and to the RCVR 97 to forward requests received from the remote clients to the plurality of PNs 100. The PN 100 establishes an Internet application session for each request for AV content received. The IOPN 300 also interfaces with the switched network to access and retrieve the AV content requested by the plurality of PNs 100. The CPN 400 operates under program control to load balance multiple AV content requests received from distinct remote clients. The CP 400 program control distributes the AV content requests among the plurality of PN 100 to mitigate against performance degradation that would otherwise result if multiple remote client AV content requests were forwarded by the IOPN 300 to the same PN 100. Thus, each PN 100 may acquire unique AV content and output a unique I-frame as a result of each remote client's AV content request and PN 100 application session. The IOPN 300 receives the I-frames and unique PIDs representing the distinct AV content requests and subsequently assembles an MPEG2 GOP transport stream for each received I-frame of AV content. The IOPN 300 outputs the GoP transport streams to post processing 200 and Multiplexing 250 in preparation for output 260 and distribution through the RBB network to the remote client.

FIG. 4e depicts a block diagram of a fourth embodiment of the present invention. This embodiment features the AV engine 1000 coupled 1002 to a DeMux Processor 600 and also to the RVCR 97 and the switched network 2. The AV engine 1000 further comprises at least one array of processing nodes. Each of the processing nodes preferably comprises a pair of dual-CPUs as depicted in FIG. 4c that are bi-directionally coupled to the other pairs of dual-CPUs.

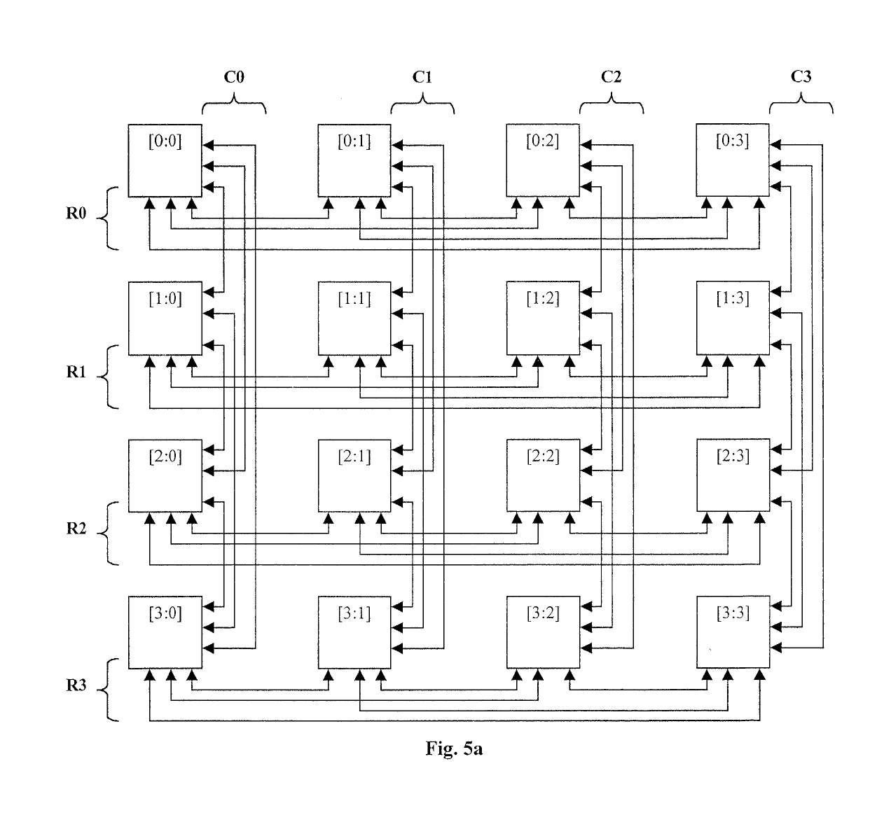

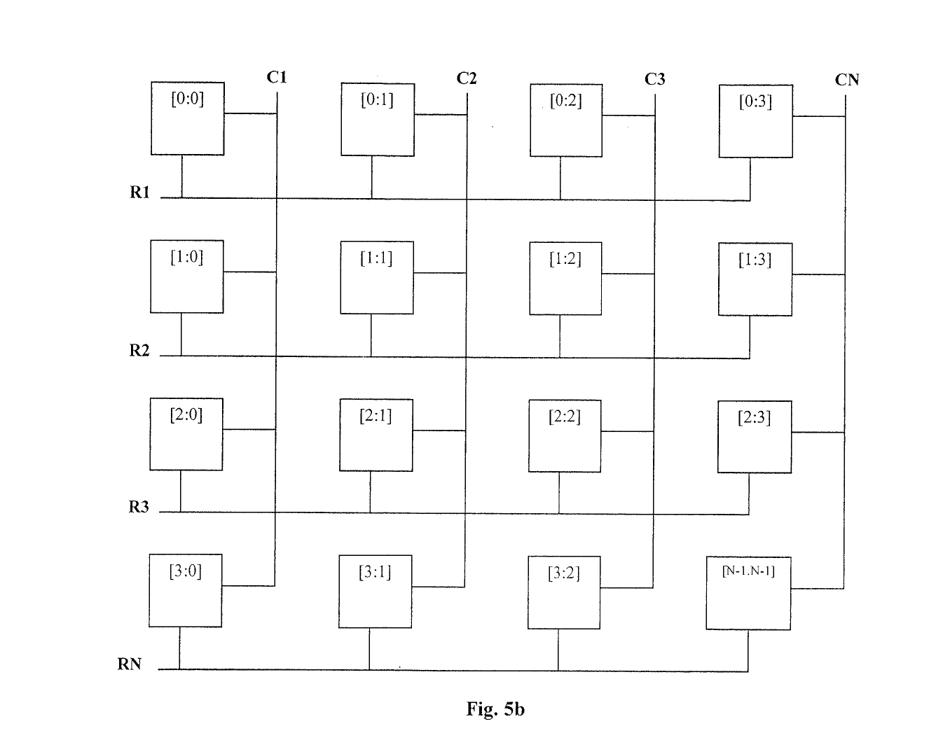

FIG. 5a depicts an 4×4 array of processing nodes with 2 orthogonal directions. Moreover, the 4×4 array of processing nodes are orthogonally coupled (R1, R2, R3, R4 and C1, C2, C3, C4,) as depicted in FIG. 5a. Orthogonally coupled processing nodes indicates that each processing node is communicatively coupled to all processing nodes in each orthogonal direction in the array. Communicative coupled processing nodes support bi-directional communications between the coupled processing nodes. Each processing node may contain a communications port for each orthogonal direction.

Each processing node may contain as many communications ports per orthogonal direction as there are other processing nodes in that orthogonal direction. In the array of FIG. 5a, such processing nodes would contain at least 6 communication ports.

FIG. 5b depicts an Nˆ M array of processing node that are orthogonally coupled (R1, R2, R3, RN and C1, C2, C3, CN). N refers to the number of processing nodes within a processing node row or column and M refers to the number of orthogonal dimensions in the array of processing nodes, which is two in FIG. 5b.

The previous illustration of orthogonal coupling between processing nodes employed direct point to point interconnections, whereas this illustration portrays orthogonal coupling as a single line for each row and column of processing nodes but still indicates orthogonal coupling as defined by R0, R1, R2, RN and C0, C1, C2, CN in FIG. 5a. Different implementations may employ at least these two interconnection schemes.

Each of the processing nodes is physically distinct and thus communication between nodes comprises traversal of the physical transport layer(s). Traversal from one processing node to another orthogonal coupled another processing node is hereinafter referred to a Hop.

Hopping via processing node orthogonal coupling enables communication between any two processing nodes in the array in at most M Hops.

P-1 additional Nˆ M arrays can be added for a total of P*(NAM) processing nodes. Orthogonal coupling between the P arrays enables communication between any two arrays in the P array in one Hop. Communication from a processing node of a first array to a processing node of a second array would take a maximum of 2*M+1 Hops.

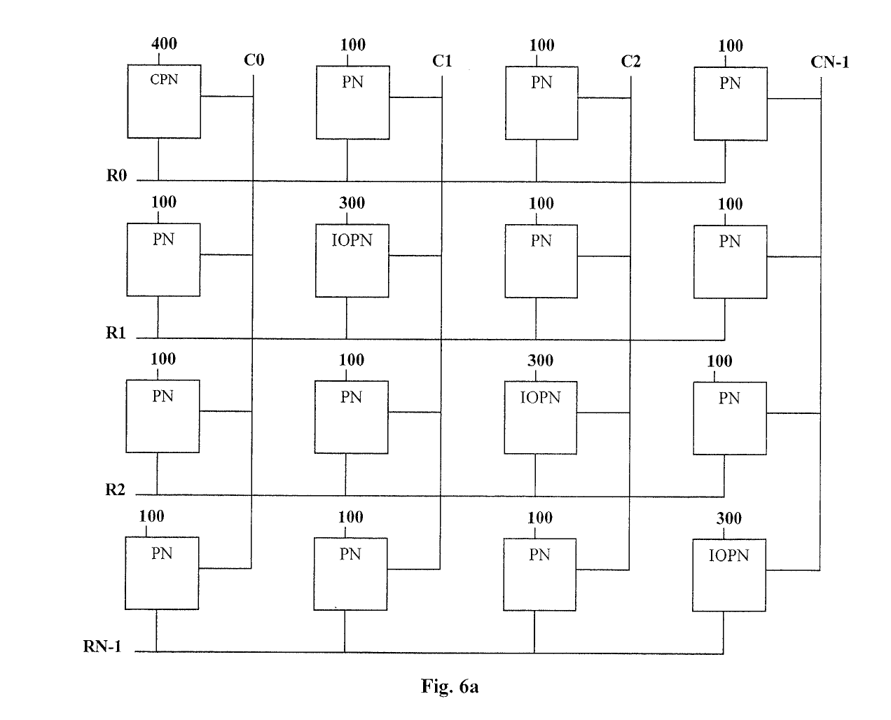

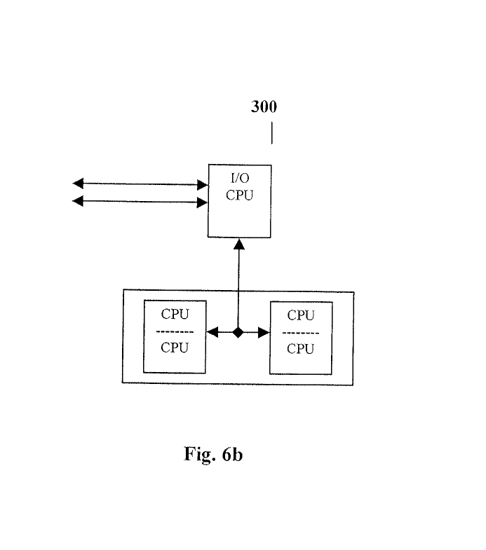

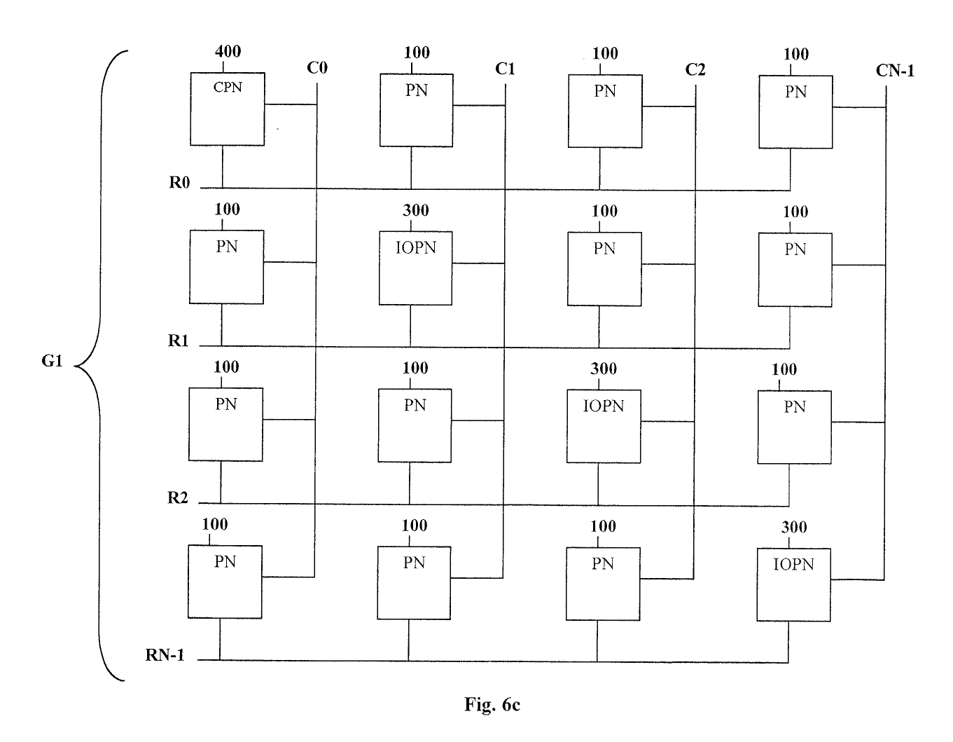

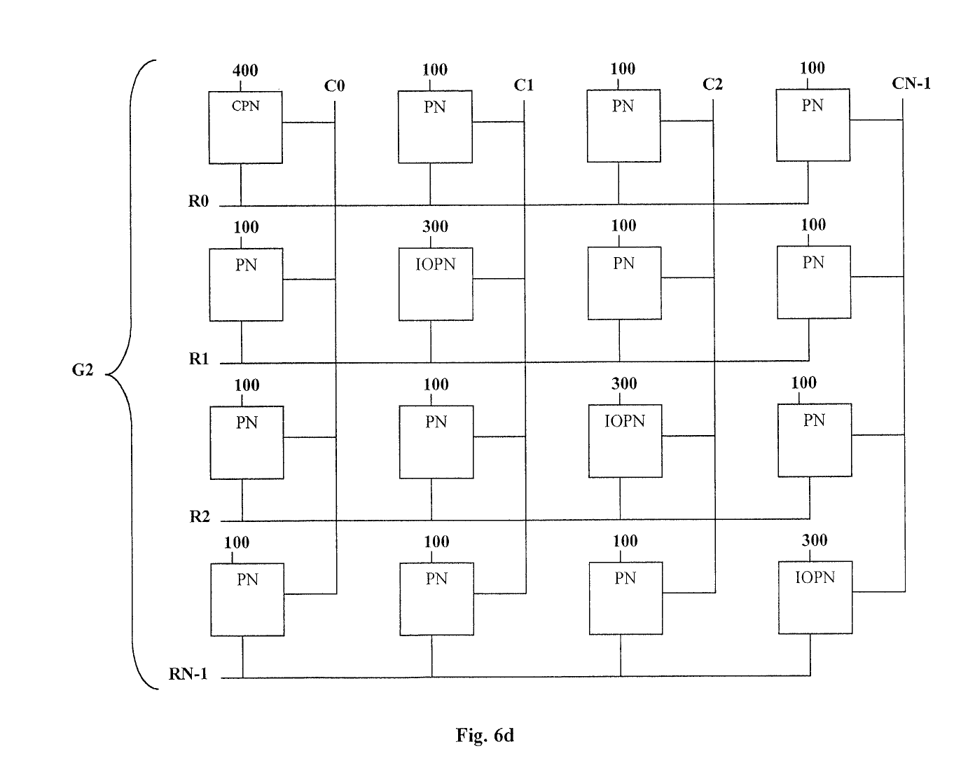

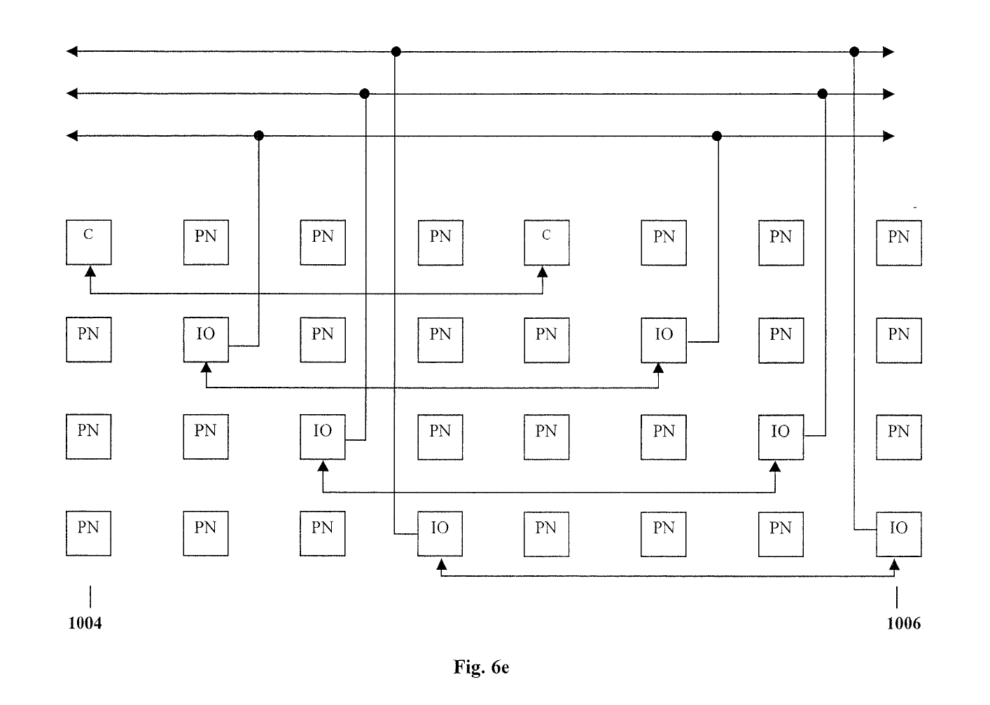

In certain embodiments implementing the processing array, the AV engine 1000 comprises a two-dimensional array of processing nodes as depicted in FIG. 6a. A CPN 400 is positioned at the coordinates [0:0] and a plurality of IOPN 300 are positioned at the processing nodes [1:1,2:2,N-1:N-1].

The CPN 400 may comprise a pair of dual-CPU. CPN 400 may further comprise an additional I/O CPU as depicted in FIG. 4c. The I/O CPU may further comprise a dual-CPU. A CPU of CPN 400, operating under program control, may perform load balancing of the remote client requests for AV content.

The IOPN 300 in this embodiment may comprise dual-CPU as depicted in FIG. 4c. IOPN 300 may further comprise a pair of dual-CPU and at least an additional I/O CPU. The I/O CPU may further comprise a dual-CPU. The I/O CPU may interface with an Ethernet switch. See FIG. 6b.

Each pair of dual-CPU within the array of processing nodes may be coupled to the other pairs of dual-CPU using a variety of communication mechanisms. These communication mechanisms support bi-directional communications. The communication mechanisms may be based upon point-to-point traversal of the physical transport layers of pairs of dual-CPU. The communications mechanisms may include a databus, fiber optics, and microwave wave guides. Such communication mechanisms may also include a messaging protocol supporting TCP-IP for example. Further embodiments support Wavelength Division Multiplex (WDM) communications through the physical transport layer(s) coupling the dual-CPU pairs.

The AV engine may comprises a first 1004, and a second 1006, two-dimensional array of processing nodes as depicted in FIGS. 6c and 6d respectively and shown collectively in FIG. 6e. The first and second arrays may contain a CPN 400 at each processing node designated by the coordinates [0:0] in each array. Further, a plurality of IOPN 300 may be positioned at the remaining processing nodes along the diagonal from the CPN 400 in each array (e.g. IOPN 300 are at the array coordinates designated by [1:1], [2:2], [N-1:N-1]). Moreover, the IOPN 300 of the first 1004 array may orthogonally couple to its corresponding IOPN 300 in the second 1006 array.

This arrangement of IOPN 300 enables input and output from any PN 100 in the arrays to any other PN 100 in the arrays after at most 5 Hops. An equivalent communication performance could also be achieved by an arrangement of the CPN 400 and the IOPN 300 along the other diagonal of the array.

FIG. 6e depicts the coupling between CPN 400 and the IOPN 300 of the first and second arrays. FIG. 6e omits the illustration of cross-coupling of processing nodes within the first 1004 and second 1006 arrays merely to reduce picture clutter and emphasize the interconnect between the first 1004 and second 1006 arrays.

In this preferred embodiment, retrieval and processing of the AV content is performed by the PN 100 upon receipt of a request for Internet AV content forward from an IOPN 300. Like the previous embodiments, each PN 100 processing a remote client AV content request passes a MJPEG frame to an IOPN 300, which in turn, formats the MPEG2 TS GoP that includes the PID expected by the remote client.

However, the delivery of multimedia content poses unique problems and is accorded special treatment by the AV Engine implementing the present invention. If at least a portion of the Internet AV content requested the remote client comprises multimedia content, the program controlling the PN 100 loads a software plug-in associated with the particular type of multimedia content requested. Thereafter, software plug-in controls the PN 100 to write the Internet Application background display content and the software plug-in writes a representation of the playback application window and associated user controls to the local memory device. Alternatively, a simple bitmap representation of the browser display screen can be prepared for remote client(s) that are incapable of decoding and displaying more than one MPEG2 window.

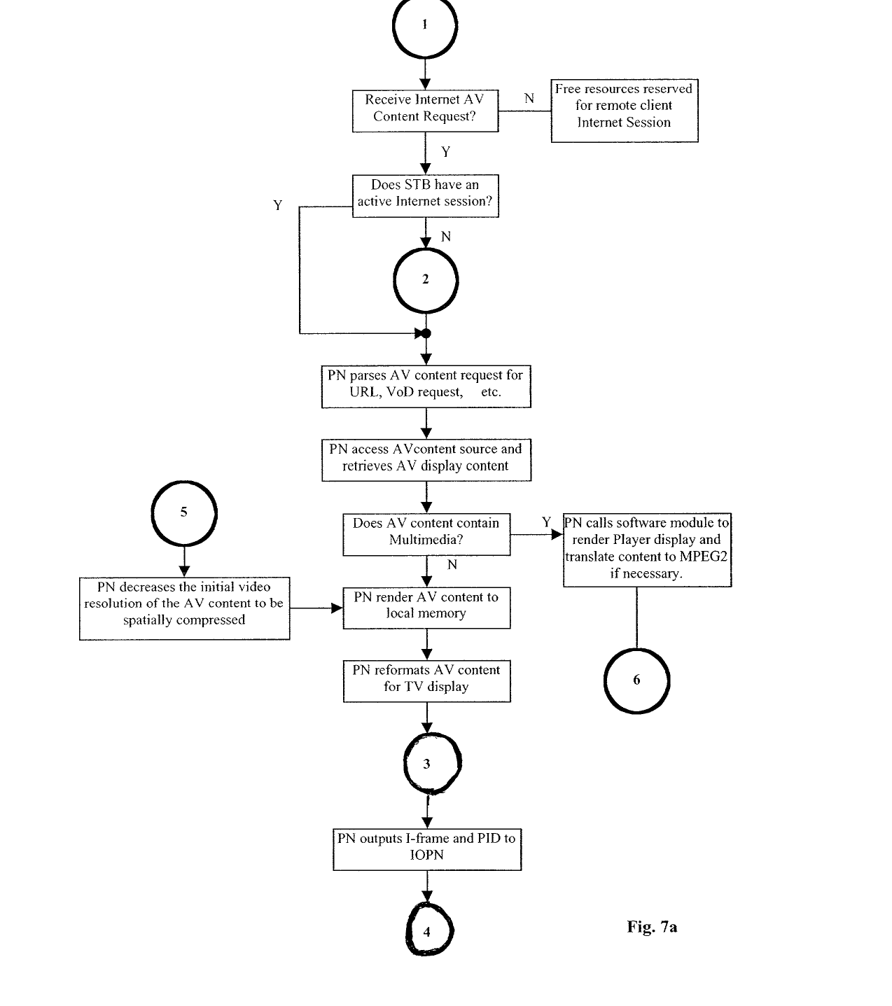

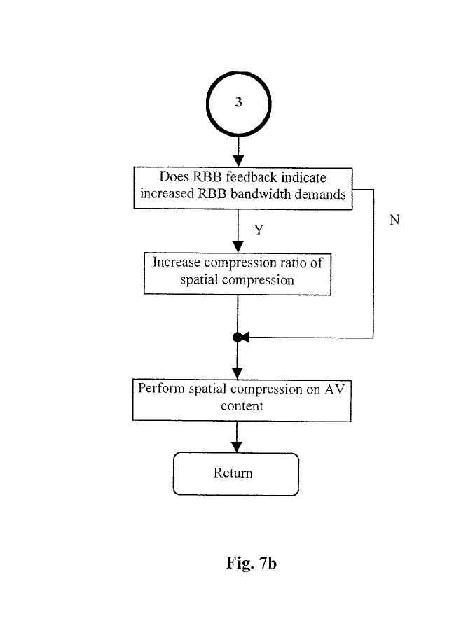

Moreover, the PN 100 skips the inter-frame encoding operation. Instead, the MPEG multimedia content is delivered directly to the IOPN 300 with the PID which forwards it to the remote client unchanged. Else, if the multimedia content comprises non MPEG content, the IOPN 300 runs another program module to translate the non MPEG2 files into MPEG2 GoP data streams for display within the playback application window coordinates of the remote client. Further, to avoid an unnecessary duplicate retrieval and translation of recently requested multimedia content, the IOPN 300 software also checks to see if the requested multimedia file has been recently requested and is therefore available in cache to be directly output as an MEPG2 TS GoP to the remote client. FIGS. 7, 8, and 9 depict a representative flow of the method of the present invention implemented on the AV Engine described herein.

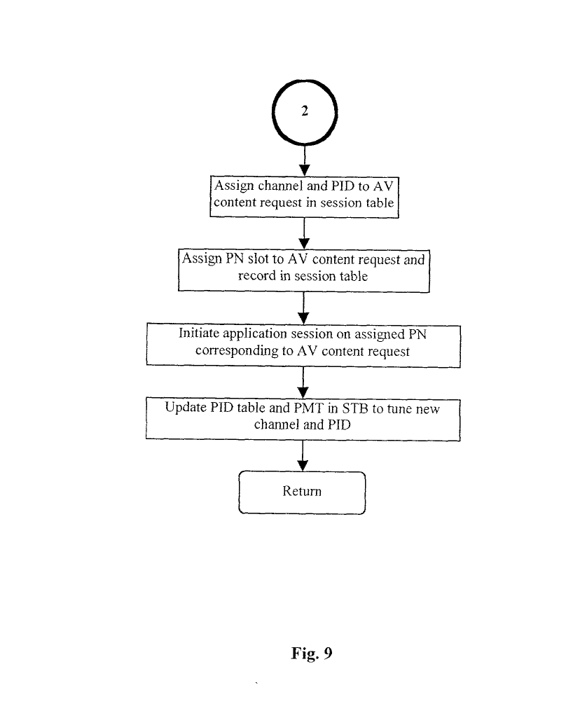

Process flow begins in FIG. 7a when the AV Engine receives an AV content request from the remote client. If this same remote client does not already have an application session operating on a PN 100, process flow transfers to FIG. 9. The operations in the process depicted in FIG. 9 perform the bookkeeping of the AV content requests.

The AV Engine assigns the AV content request from the remote client a PID and channel number in a session table kept within the memory of the AV Engine. The AV Engine further assigns the AV content requests to a PN 100 and records that assignment in the session. The AV Engine finally establishes a communication session back to the remote client to communicate any updates in channel and PID assignments. The AV Engine then initiates the applications session on the PN 100 that corresponds to the AV content request. The application session may include for example, an Internet Browser Application session, an email application session, or a Video-on-Demand client to access a server. Process flow then returns to the operations depicted in FIG. 7a.

The PN 100 parses the AV content request for the desired AV content, which may include a number of types of AV content. The PN 100 next accesses the AV content request that contains the AV content and retrieves the content. If the requested AV content already contains MPEG2 content, the PN 100 loads a software module to draw the playback application window and control features into local memory. The retrieved MPEG2 content is then ported directly to the IOPN 300. There may also be circumstances when the AV content requested is in format other than MPEG2, if so, the IOPN 100 loads a module that instead translates the AV content as it is being output from the AV Engine. If the retrieved AV content is not a multimedia format, the AV content is rendered to local memory. Additionally, any formatting changes that will modify the AV content to further the compatibility with a television display are performed (e.g. interleaving, aspect ratio change, etc.). Process flow then performs the operations depicted in FIG. 7b.

FIG. 7b includes steps that depict dynamic spatial compression of the AV content. If feedback from the RBB indicates to the AV Engine that available bandwidth is dwindling due to increased demand, software controlling the PN 100 increases the compression ratio prior to processing of the AV content. For example, higher-order DCT coefficients that are ordinarily included in the array of DCT array of coefficients may be rounded to zero. The AV content is then compressed via run-length encoding to compress the frame of AV content. It follows that an array containing a greater number of zero coefficients will require less bandwidth than one with more non-zero coefficients. The compressed frame substantially comprises an MPEG2 I-frame after compression.

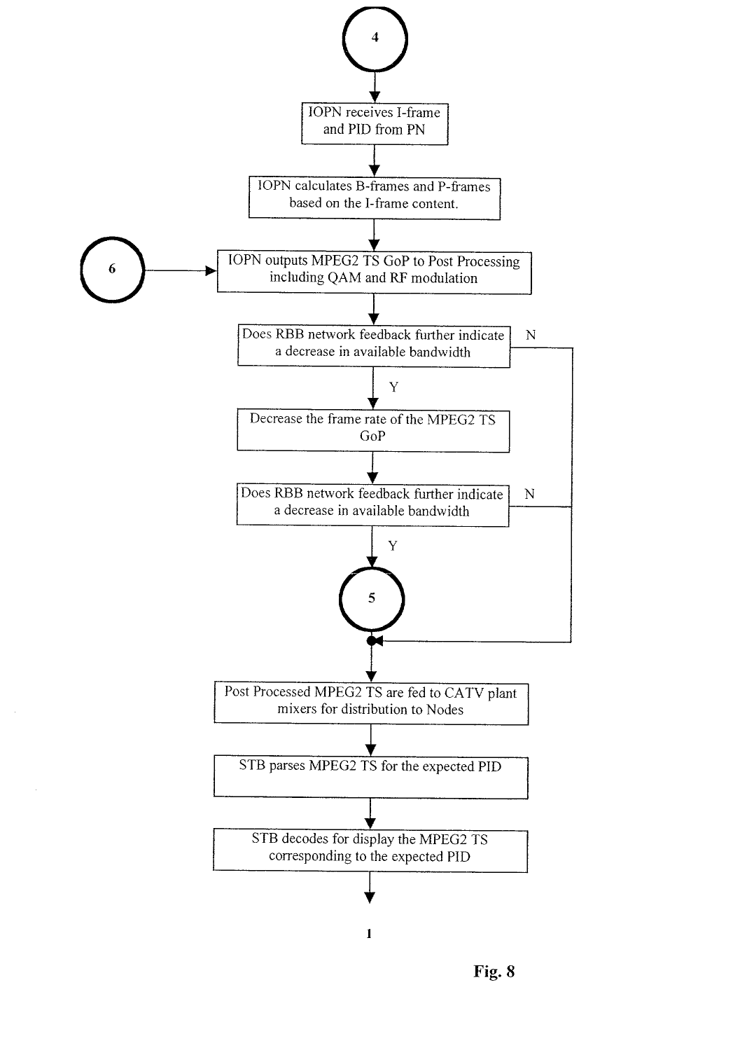

The PN 100 then signals to the IOPN 300 that the I-frame of AV content is available for output. In certain embodiments, signaling the IOPN 300 is performed by storing the compressed AV content in a memory location accessible by the IOPN 300. In certain embodiments, signaling further comprises memory storage and the setting a flag associated with the memory location. In still further embodiments, signaling the IOPN 300 comprises outputting the compressed AV content to the IOPN 300. Process flow continues with the operations depicted in FIG. 8.

FIG. 8 depicts the operations performed by the IOPN 300. Upon the acquisition of the compressed frame of AV content, the IOPN 300 formats the compressed frame of AV content to form an actual MPEG2 I-frame and also calculates B-frames and P-frames and appends the channel and PID that is available either from the PN 100 or the session table discussed earlier. The MPEG2 TS GoP together with the appended PID are then output from the AV Engine to the CATV fiber distribution plant for transmittal to the remote client that requested the AV content. Moreover, at this point in the flow there is a further opportunity to reduce the bandwidth necessary to transmit the AV content.

If the BAF indicates that bandwidth availability has decreased, the software of the IOPN 300 decreases the number, of I-frames, B-frames, or P-frames transmitted. Further, the software of the IOPN 300 may reduce the frame rate using any combination and number of the MPEG2 frames. Finally, FIG. 8 depicts a further opportunity to cause a reduction in the bandwidth necessary to transmit the MPEG2 AV content. If feedback from the RBB network further indicates that bandwidth availability has decreased, the AV Engine further reduces the video resolution that is to be spatially compressed by the PN 100. Thus, fewer pixels are compressed during the spatial compression operation resulting in a smaller array of DCT coefficients, and hence smaller frame lengths. Certain embodiments of the AV Engine use one, two, or all three techniques to reduce the bandwidth necessary to transmit the MPEG2 AV content.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

1. In a processor system, a method of dynamically adjusting the quantity of compression performed on visual content delivered over a network to a remote client, comprising:
receiving a request for visual content from a remote client;
retrieving the visual content to a local memory,
receiving feedback regarding a change in demand for bandwidth on the network;
increasing the compression ratio of visual content in response to increasing demand for bandwidth and decreasing the compression ration of visual content in response to decreasing demand for bandwidth;
accessing the local memory to retrieve the visual content;
compressing the visual content to form a plurality of data frames that are representative of the visual content, and
outputting the plurality of data frames to the remote client.

2. The method in claim 1 wherein compressing the visual content to form a plurality of data frames that are representative of the visual content further comprises,
spatially, compressing the visual content to form a data frame that is representative of the visual content; and
duplicating the data frame to form the plurality of data frames.

3. The method in claim 2 wherein, spatially compressing the visual content further comprises,
transforming the frequencies present in the visual content into a plurality of coefficients that are representative of the frequencies present in the visual content;
omitting at least a portion of the plurality of coefficients that are representative of the higher frequencies present in the visual content; and
forming the data frame from the remaining coefficients.

4. The method in claim 1 wherein, compressing the visual content to form a plurality of data frames that are representative of the visual content further comprises,
spatially, compressing the visual content to form a data frame that is representative of the visual content; and
temporally, compressing the data frame to form the plurality of data frames.

5. The method in claim 4 wherein, spatially compressing the visual content further comprises,
transforming the frequencies present in the visual content into a plurality of coefficients that are representative of the frequencies present in the visual content;
omitting at least a portion of the plurality of coefficients that are representative of the higher frequencies present in the visual content; and
forming the data frame from the plurality of remaining coefficients.

6. The method of claim 1 wherein, compressing the visual content to form a plurality of data frames, and increasing/decreasing the compression ratio of visual content comprises,
generating a non-spatially compressed data frame of visual content,
temporally, compressing the non-spatially compressed data frame to form the plurality of data frames.

7. The method in claim 6 wherein, temporally, compressing the non-spatially compressed data frame to form the plurality of data frames comprises,
reducing the rate of outputting data frames to the remote client.

8. The method in claim 7 wherein,
the plurality of data frames comprise an MPEG2 Transport Stream.

9. The method of claim 8 wherein,
the reduced rate of data frames outputted consists of a reduction of at least one type of frame selected from the group consisting of; I-frames, B-frames, or P-frames.

10. The method in claim 1 wherein, compressing the visual content to form a plurality of data frames that are representative of the visual content further comprises,
reducing the resolution of the visual content stored to the local memory.

11. The method in claim 1 wherein, compressing the visual content to form a plurality of data frames that are representative of the visual content further comprises, reducing the resolution of the visual content stored to the local memory;
spatially, compressing the visual content to form a data frame that is representative of the visual content; and
temporally, compressing the data frame to form the plurality of data frames.

12. The method in claim 11 wherein,
the plurality of data frames comprises an MPEG2 Transport Stream.

13. The method of claim 12 wherein,
the reduced rate of data frames outputted consists of a reduction of at least one type of frame selected from the group consisting of; I-frames, B-frames, or P-frames.

14. The method in claim 1 wherein,
the feedback regarding a change in demand from bandwidth originates externally from the processor system.

15. The method in claim 14 wherein, receiving feedback regarding a change in demand for bandwidth on the network further comprises,
communicating with a component that is coupled to a CATV programming distribution system and located at a site selected from the group consisting of; a Node, a local Headend, or a Metropolitan Headend.

16. The method of claim 1 wherein,
the feedback regarding a change in demand bandwidth originates from within the processor system.

17. The method of claim 1 wherein,
the feedback correlates to the quantity of requests for visual content received by the processor system.

18. The method of claim 1 wherein,
the plurality of data frames output to the remote client comprises an MPEG2 transport stream.

19. The method of claim 18 further comprising,
communicating a combination of a unique channel and Program Identifier to the remote client that carries the MPEG2 transport stream.

20. The method of claim 1 further comprising,
establishing an application session.

21. The method of claim 21 wherein,
the application session is selected from the group consisting of; an Internet Browser, and an Email application.

22. The method in claim 1 further comprising,
accessing a server through a switched network.

23. The method of claim 22 wherein,
the switched network comprises the Internet.

24. The method in claim 1 wherein,
the network through which the visual content is delivered comprises a broadband network.

25. The method in claim 24 wherein,
the broadband network comprises a CATV broadband network.

26. In a processor system, a method of dynamically adjusting the quantity of compression performed on motion video or audio content delivered over a network to a remote client, comprising:
receiving a request for motion video or audio content from a remote client;
receiving feedback regarding a change in demand for bandwidth on the network;
increasing the compression ratio of visual content in response to increasing demand for bandwidth and decreasing the compression ration of visual content in response to decreasing demand for bandwidth;
compressing the motion video or audio content to form a plurality of data frames that are representative of the visual content, and
outputting the plurality of data frames to the remote client.

27. The method in claim 6 wherein, compressing the non-spatially compressed data frame to form the plurality of data frames comprises, reducing reducing the rate of outputting data frames to the remote client.

28. The method in claim 27 wherein, the plurality of data frames comprise an MPEG2 Transport Stream.

29. The method of claim 28 wherein,
the reduced rate of data frames outputted consists of a reduction of at least one type of frame selected from the group consisting of; I-frames, B-frames, or P-frames.

30. The method in claim 26 wherein,
the feedback regarding a change in demand from bandwidth originates externally from the processor system.

31. The method in claim 30 wherein, receiving feedback regarding a change in demand for bandwidth on the network further comprises,
communicating with a component that is coupled to a CATV programming distribution system and located at a site selected from the group consisting of; a Node, a local Headend, or a Metropolitan Headend.

32. The method of claim 26 wherein,
the feedback regarding a change in demand from bandwidth originates from within the processor system.

33. The method of claim 26 wherein,
the feedback correlates to the quantity of requests for motion video or audio content received by the processor system.

34. The method of claim 26 wherein,
the plurality of data frames output to the remote client comprise an MPEG2 transport stream.

35. The method of claim 34 further comprising,
communicating a combination of a unique channel and Program Identifier to the remote client that carries the MPEG2 transport stream.

36. The method in claim 26 further comprising,
accessing a server through a switched network.

37. The method of claim 36 wherein,
the switched network comprises the Internet.

38. The method of claim 36 wherein,
the server comprises a video-on-demand server.

39. The method in claim 26 wherein,
the network through which the visual content is delivered comprises a broadband network.

40. The method in claim 39 wherein,
the broadband network comprises a CATV broadband network.

41. A processing engine for the delivery of audio or multimedia content through a broadband network, comprising:
P arrays of MAN processing nodes, where N refers to the number of processing nodes within a processing node row or column, M refers to the number of orthogonal dimensions of the array of processing nodes, and P refers to the number of arrays of processing nodes.

42. The processing engine in claim 41 wherein,
M is at least four, N is two and P is at least one.

43. The processing engine in claim 42 wherein,
P at least two.

44. The processing engine in claim 41 wherein,
for each arrays, each of the processing nodes are orthogonally coupled to all orthogonal processing nodes in each orthogonal direction and support orthogonal communications between orthogonal processing nodes.

45. The processing engine in claim 44 wherein,
each processing node comprises at least M communication ports, at least one communication port supports orthogonal communications with the orthogonal coupled processing nodes for each orthogonal direction.

46. The processing engine in claim 44 wherein,
orthogonal communication between processing nodes comprises traversal of the physical transport layers of the orthogonal coupling between the processing nodes.

47. The processing engine of claim 46 wherein,
the physical transport layer consists of a physical media selected from the group consisting of; fiber-optics, a databus, twisted pair, or microwave wave guide.

48. The processing engine of claim 41 wherein,
each processing node comprises at least a bi-directionally coupled pair of processing units.

49. The processing engine of claim 48 wherein
each processing unit comprises a bi-directionally coupled dual-CPU within the same package.

50. The processing engine of claim 41 wherein,
at least a portion of the processing nodes further comprise a communications processing unit that is bi-directionally coupled to a switched network.

51. The processing engine of claim 41 wherein,
at least a portion of the processing nodes further comprise a communications processing.

52. The processing engine of claim 51 wherein
the communications unit is bi-directionally coupled to a switched network.

53. The processing engine of claim 52 wherein
the switched network comprises the internet.

54. The processing engine of claim 51 wherein,
the communications unit is coupled to a broadband network.

55. The processing engine of claim 54 wherein,
the broadband network comprises a Hybrid-Fiber Coaxial CATV distribution network.

56. The processing engine of claim 50 wherein,
the processing nodes further comprising a communications processing unit are positioned along a diagonal of the array of processing nodes.
